(19) United States
(12) Patent Application Publication
(10) Pub. No.: US 2017/0188513 A1
(43) Pub. Date: Jul. 6, 2017

(54) AGRICULTURAL OR INDUSTRIAL VEHICLE LADDER WITH POWERED ELEVATING STEPS

(71) Applicant: AGCO Corporation, Hesston, KS (US)

(72) Inventors: Donald Lee Kluver, III, Hesston, KS (US); Dino Rey Valdez, Hesston, KS (US); Stephen Samuel McMaster, Hesston, KS (US)

(21) Appl. No.: 15/389,705

(22) Filed: Dec. 23, 2016

Related U.S. Application Data
(60) Provisional application No. 62/273,327, filed on Dec. 30, 2015.

(51) Int. Cl. A01D 41/12; E06C 5/04; B60R 3/02; E02F 9/08

(52) U.S. Cl. CPC A01D 41/1261; E02F 9/0833; E06C 5/04; B60R 3/02

(57) ABSTRACT

A powered ladder is operable to move a person vertically relative to an agricultural or industrial vehicle. The ladder broadly includes an elongated ladder frame, a step, and a step drive. The ladder frame includes a pair of ladder rails that cooperatively define an upright ladder axis and a path therebetween, with the path extending along the ladder axis. The step is shiftably attached to the ladder frame and is positioned at least partly within the path. The step drive is drivingly connected relative to the step to drive the step between upper and lower positions.

### CROSS REFERENCE TO RELATED APPLICATION

This application claims the benefit of U.S. Provisional Application No. 62/273,327 filed Dec. 30, 2015, which is hereby incorporated by reference in its entirety.

### BACKGROUND

Field of Invention

The present invention relates generally to agricultural and industrial equipment. More specifically, embodiments of the present invention concern a powered ladder that is used as part of an agricultural vehicle or other industrial vehicle.

Discussion of Prior Art

Conventional harvesters and other large self-propelled agricultural and industrial vehicles commonly have an enclosed operator cab mounted in an elevated position. Such vehicles include a series of steps, often in the form of a ladder, for a person to ascend to the cab by climbing up the steps, or to descend from the cab by climbing down the steps.

However, conventional vehicle ladders and steps for agricultural vehicles and other industrial vehicles have various deficiencies. For instance, ladders and steps of conventional vehicles are difficult for a person to climb and can be potentially dangerous to climb. The difficulty of climbing conventional ladders and steps is particularly evident if the person has limited physical range of motion (e.g., due to inflexibility or injury), is overweight, has poor cardiovascular fitness, and/or has poor muscular fitness.

### SUMMARY

The following brief summary is provided to indicate the nature of the subject matter disclosed herein. While certain aspects of the present invention are described below, the summary is not intended to limit the scope of the present invention.

Embodiments of the present invention provide a powered ladder for an agricultural or industrial vehicle that does not suffer from the problems and limitations of the prior art ladders and steps set forth above.

A first aspect of the present invention concerns a powered ladder for an agricultural or industrial vehicle, wherein the ladder is operable to move a person vertically relative to the agricultural or industrial vehicle. The powered ladder broadly includes an elongated ladder frame, a step, and a step drive. The ladder frame includes a pair of ladder rails that cooperatively define an upright ladder axis and a path therebetween, with the path extending along the ladder axis. The step is shiftably attached to the ladder frame and is positioned at least partly within the path, with the step being shiftable along the path between upper and lower positions. The step drive is drivingly connected relative to the step to drive the step between the upper and lower positions.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Preferred embodiments of the invention are described in detail below with reference to the attached drawing figures, wherein:

FIG. 1 is a perspective of a powered ladder constructed in accordance with a preferred embodiment of the present invention, with the powered ladder being shown as part of a self-propelled harvester;

FIG. 2 is a front perspective of the powered ladder shown in FIG. 1, showing a ladder frame, hand railing, and a slidable step assembly of the ladder, with the ladder frame including a pair of ladder rails with tracks to support the step assembly, and showing the step assembly in a lowermost position;

FIG. 3 is a rear perspective of the powered ladder shown in FIGS. 1 and 2, showing a linear actuator of the ladder attached to an outer surface of the ladder frame, with the step assembly including arms attached to a slidable carrier of the actuator;

FIG. 4 is a side elevation of the powered ladder shown in FIGS. 1-3, showing the step assembly in an uppermost position; and

FIG. 5 is a lower perspective of the powered ladder shown in FIGS. 1-4, showing part of the ladder frame broken away to show a step structure of the step assembly mounted to the arms with fasteners that extend through the tracks, and also showing bearings operably mounted to the fasteners and slidably positioned within the tracks.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

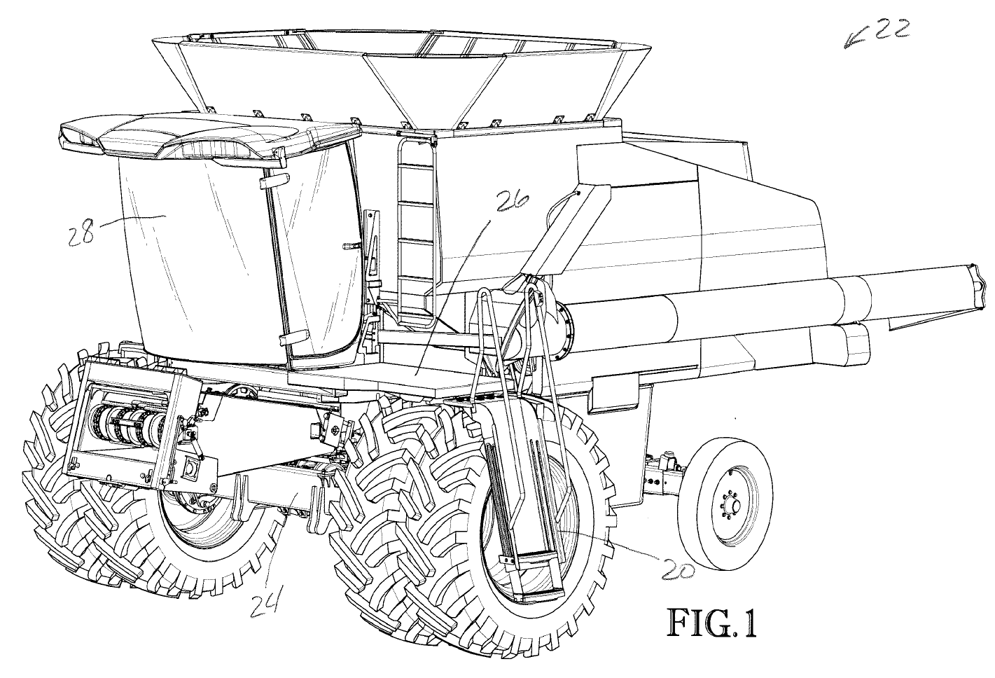

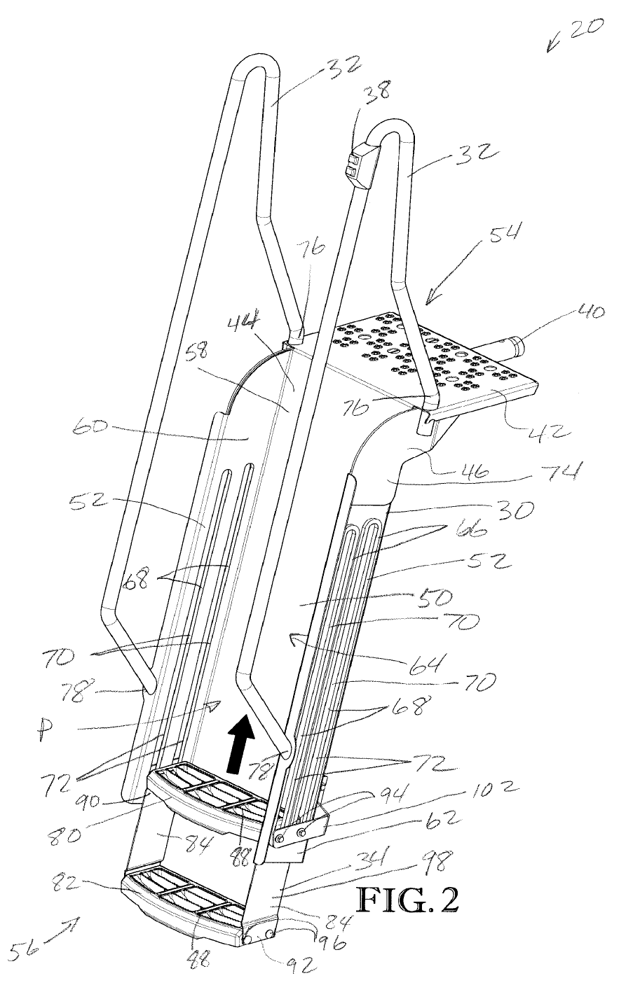

Turning initially to FIGS. 1 and 2, a powered ladder 20 is constructed in accordance with a preferred embodiment of the present invention. The ladder 20 is configured to transport a person (not shown) between the ground and a location spaced above the ground on an agricultural or industrial vehicle 22. In the illustrated embodiment, the vehicle 22 is depicted in the fom1 of a self-propelled agricultural harvester, with the understanding that aspects of the present invention are equally applicable to industrial vehicles or other agricultural vehicles. The illustrated harvester 22 includes a powered chassis 24, a platform 26, an operator cab 28, and the ladder 20.

In general, the ladder 20 is used to transport a person between the ground and the platform 26 to permit selective cab ingress and egress. However, it will be appreciated that the ladder 20 could be alternatively used. Again, the ladder 20 could be incorporated as part of various types of self-propelled agricultural vehicles, or other industrial vehicles, particularly where an operator cab of the vehicle is spaced significantly above the ground. The ladder 20 preferably includes a ladder frame 30, a hand railing 32, slidable step assembly 34, a linear actuator 36, and an operator control switch 38.

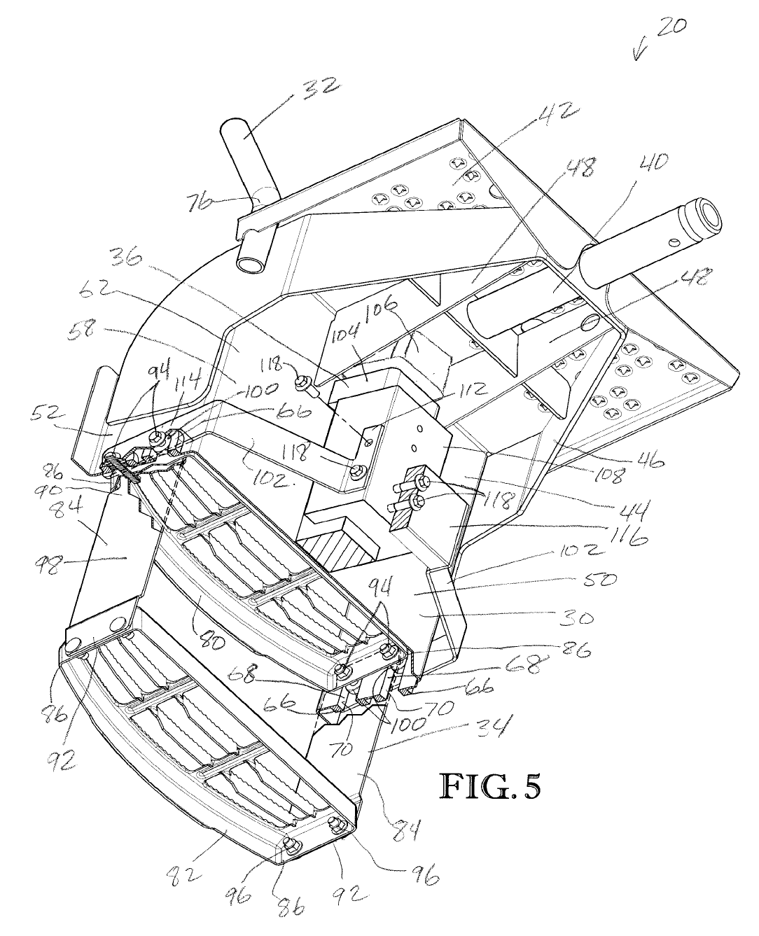

Turning to FIGS. 1-5, the ladder frame 30 is configured to support the step assembly 34, and any person on the step assembly 34, during operation of the ladder 20. Preferably, the ladder frame 30 is generally rigid and includes a support beam 40, platform 42, body 44, brace 46, and gussets 48 that are fixed to one another (see FIG. 5).

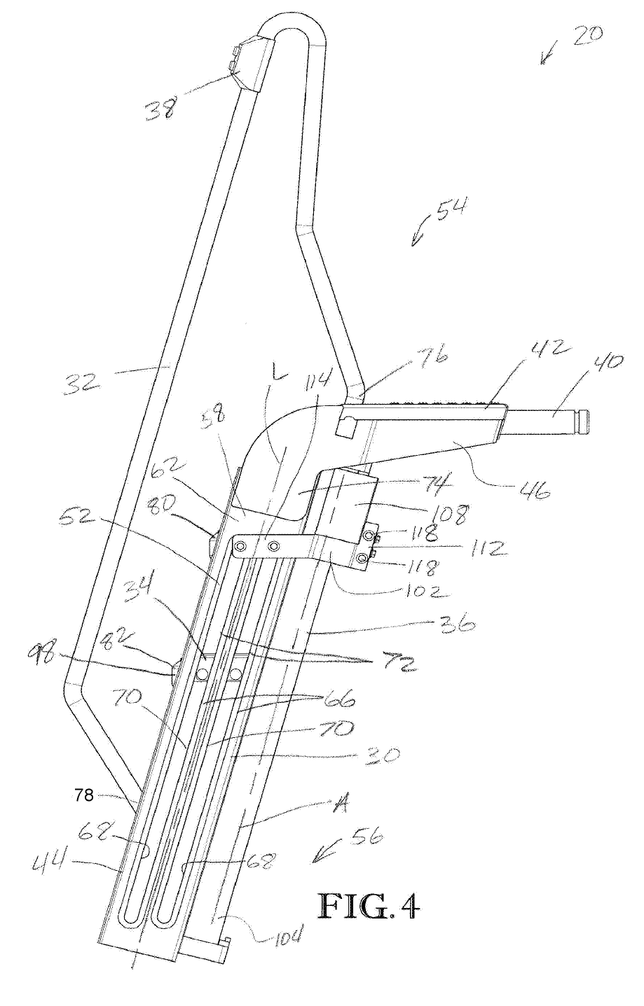

The body 44 serves to support the step assembly 34 and defines an upright ladder axis L along which the step assembly 34 can move (see FIG. 4). Furthermore, the body 44 guides the step assembly 34 along the ladder axis L between a lowermost position (see FIGS. 1-3) and an uppermost position (see FIGS. 4 and 5). The body 44 preferably includes a base 50 and a pair of ladder rails 52 and presents upper and lower ladder ends 54, 56. The illustrated base 50 and ladder rails 52 extend continuously between the ladder ends 54,56. However, it is within the scope of the present invention where the base 50 and/or ladder rails 52 are alternatively shaped. For instance, the base 50 could include one or more base segments that extend partly along the ladder length and interconnect the ladder rails 52. In one alternative embodiment, the ladder 20 could include multiple base segments spaced in series between the ladder ends 54, 56.

The illustrated body 44 includes a unitary, rigid sheet 58 that is formed to define the base 50 and parts of the ladder rails 52 (e.g., sheet steel formed in a press brake). However, the base 50 and/or ladder rails 52 could be alternatively formed without departing from the scope of the present invention.

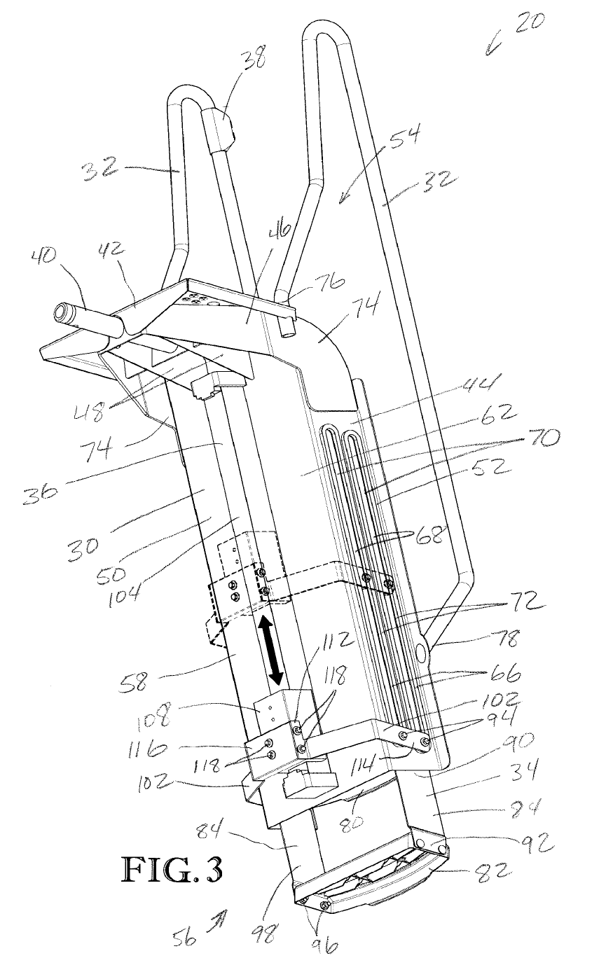

The rigid sheet of the body 44 presents a continuous inner channel surface 60 and an outer surface 62 (see FIGS. 2 and 3). The channel surface 60 preferably defines a channel 64 that extends continuously between the upper and lower ends 54,56 (see FIG. 2). The illustrated channel 64 comprises an axial path P that is cooperatively formed by the base 50 and ladder rails 52 to extend along the ladder axis L. However, it is within the scope of the present invention where the path P is alternatively defined (e.g., where the path P is formed solely by the ladder rails 52). As will be explained, the ladder 20 is configured so that at least part of the step assembly 34 is positioned within the path 64.

The ladder rails 52 each include endless bearing rims 66 that are fixed to the sheet 58. The bearing rims 66 preferably present inner bearing surfaces 68. The sheet 58 and bearing rims 66 cooperatively define axially extending slots 70 in the ladder rails 52. As will be subsequently explained, the ladder rails 52 provide tracks 72 that are configured to slidably receive the step assembly 34.

The illustrated ladder rails 52 each preferably include a pair of the slots 70. However, the ladder rails 52 could be alternatively configured to slidably support the step assembly 34 without departing from the scope of the present invention. For instance, each ladder rail could alternatively present a single slot or more than two (2) slots defining the alternative track.

Furthermore, the ladder rails 52 could include one or more tracks 72 that do not form a slot completely through the ladder rail 52. For instance, each ladder rail could alternatively present an inwardly facing recessed channel that opens toward the opposite ladder rail and provides a track to slidably support the step assembly. Also, each ladder rail could have an elongated, male, rail structure that provides a track to slidably support the step assembly (e.g., where the step assembly has complemental female features that are slidably mounted on the rail structures).

It will also be appreciated that another part of the ladder frame 30 could have one or more tracks to slidably support the step assembly 34. For instance, the base 50 could include one or more tracks to support the step assembly 34.

The platform 42 and beam 40 are fixed to one another and positioned adjacent the upper ladder end 54. The platform 42 and beam 40 are preferably connected to the body 44 by a brace 46. The brace 46 comprises an elongated, rigid sheet that is folded to present two arm sections 74 that are fixed to corresponding ladder rails 52. The gussets 48 are fixed to the body 44 and the platform 42 to reinforce the ladder 20 and restrict movement between the body 44 and the platform 42.

Each hand railing 32 is operable to be grasped by a person as the person is supported on the step assembly 34. The hand railing 32 includes a unitary, rigid tube with various bends. The hand railing 32 presents upper and lower ends 76, 78 that are fixed to corresponding ladder rails 52 and arm sections 74 of the brace 46.

The step assembly 34 is configured to support a person during operation of the ladder 20 and can slide along the axis L between the uppermost and lowermost positions. In particular, the step assembly 34 can support a person while the step assembly 34 is stopped. The step assembly 34 can also support a person while the step assembly 34 moves up or down along the path P. In the lowermost position, the ladder 20 is preferably configured so that a person can readily step in an upward direction from the ground onto the step assembly 34. Similarly, the person can step downwardly from the step assembly 34 to the ground in the lowermost position. In the uppermost position, the ladder 20 is preferably configured so that the person can step from the step assembly 34 to the platform 42, and vice versa.

The step assembly 34 preferably includes upper and lower steps 80, 82 and a pair of plates 84 that interconnect the steps 80, 82. Each step 80, 82 has a unitary construction and is elongated to present opposite step ends 86 (see FIG. 5). The steps 80, 82 each present a perforated upper step surface 88 that faces upwardly (see FIG. 2). The steps 80, 82 are preferably formed from a metallic sheet material. However, the steps 80, 82 could be alternatively constructed within the scope of the present invention.

Each of the plates 84 comprises a unitary piece of sheet metal that presents opposite upper and lower plate ends 90, 92 (see FIG. 5). However, the plates 84 could be alternatively constructed within the scope of the present invention.

The plates 84 and steps 80, 82 are preferably connected to each other with upper and lower fasteners 94, 96 (see FIG. 5). In particular, the upper step 80 is connected to the upper plate ends 90 with upper fasteners 94. The lower step 82 is connected to the lower plate ends 92 with lower fasteners 96. The plates 84 and steps 80, 82 are connected to cooperatively form a substantially rigid step structure 98 with a pair of steps.

However, it is within the scope of the present invention where the rigid step structure 98 is alternatively configured. For instance, the steps 80, 82 could be alternatively positioned relative to one another. Also, the step structure 98 could have an alternative number of steps (e.g., where the step structure includes a single step or more than two steps).

The step structure 98 is preferably slidably mounted on the ladder frame 30 to slide up and down along the ladder axis L. The illustrated step assembly 34 further includes ball bearings 100 and a pair of arms 102 (see FIG. 5). The illustrated ball bearings 100 are rotatably mounted to the upper fasteners 94 and secured between corresponding plates 84 and arms 102. The ball bearings 100 are each positioned within a respective one of the slots 70 to engage a corresponding bearing surface 68 and rotate as the step structure 98 slides along the ladder axis L.

The illustrated arms 102 are preferably attached to the step structure 98 with upper fasteners 94. The upper fasteners 94 preferably serve as a connecting structure that extends through the corresponding slot 70 to interconnect the step structure 98 and the respective arm 102. Thus, the upper fasteners 94, the tracks 72, and ball bearings 100 cooperatively permit sliding movement of the step structure 98 along the ladder axis L.

While the ball bearings 100 are preferably used to provide smooth sliding movement of the step structure 98, an alternative bearing arrangement could be used to support the step structure 98 on the ladder frame 30. For instance, the step structure could have bearings mounted to both upper and lower fasteners. Also, the bearings 100 could be slidably engaged with a structure other than the ladder rails 52. For instance, the base could present bearing surfaces to slidably receive the bearings (e.g., where the bearing surfaces define slots within the base).

It is also within the scope of the present invention where the step structure 98 is alternatively positioned for sliding movement along the ladder frame 30. For instance, the step structure 98 could be positioned entirely above the lower end 56 of the body 44 in the lowermost position.

The linear actuator 36 is configured to drive the step assembly 34 axially between the uppermost and lowermost positions. The linear actuator 36 is preferably sized to provide this sliding movement whether or not the step assembly 34 is occupied by a person.

The linear actuator 36 includes a housing 104, an electric motor 106, and a carrier 108 that is slidable along an actuator axis A from the uppermost position to the lowermost position. The actuator 36 is preferably positioned so that the actuator axis A is generally parallel to the ladder axis L. The linear actuator 36 preferably comprises an electrically-powered linear drive and, more preferably, comprises a BCS Rodless Screw Drive Actuator, manufactured by Tolomatic, Inc. of Hamel, Minn.

However, the actuator 36 could be alternatively configured without departing from the scope of the present invention. For instance, the actuator could alternatively comprise a hydraulically-powered linear actuator. Furthermore, a drive mechanism other than a linear actuator could be used to move the step structure 98. For instance, the ladder 20 could include a rack-and-pinion drive (not shown) to shiftably move the step structure 98. Although the ladder 20 preferably includes a single actuator, the ladder 20 could alternatively include a pair of actuators that are attached to corresponding step ends 86 of the upper step 80.

The linear actuator 36 preferably receives electrical power from a battery (not shown) of the harvester 22. The control switch 38 preferably comprises a 3-way manual switch fixed to a corresponding hand railing 32. The switch 38 allows a person to drive the carrier 108 in either an upward direction or a downward direction. The switch 38 can also be switched to stop the carrier 108 from moving.

The linear actuator 36 is preferably fixed to the outer surface 62 of the base 50 with fasteners (not shown). That is, the linear actuator 36 is preferably positioned exterior to the path 64. However, the linear actuator 36 could be alternatively mounted relative to the ladder frame 30. For instance, the linear actuator 36 could be mounted on or adjacent to the outer surface 62 of one of the ladder rails 52. Yet further, for some aspects of the present invention, the linear actuator 36 could be mounted within the path 64 (e.g., where the linear actuator 36 is mounted on the channel surface 60).

Each arm 102 is unitary and preferably comprises a substantially rigid structure that presents a carrier margin 112 and a step margin 114 (see FIG. 4). The step assembly 34 includes a mounting block 116 that is attached to the carrier 108 with fasteners 118. The carrier margins 112 of the arms 102 are preferably attached to the block 116 with fasteners 118. The arms 102 are preferably positioned so that the step margins 114 are positioned outboard of the ladder rails 52 and exterior of the path 64.

The illustrated arms 102 are preferably attached to the step structure 98 with upper fasteners 94. The upper fasteners 94 preferably serve as a connecting structure that extends through the corresponding slot 70 to interconnect the step structure 98 and the respective arm 102.

It is within the ambit of the present invention where the actuator 36 is alternatively connected relative to the step structure 98. For instance, an alternative ladder configuration could include connecting structure that extends through one or more slots in the base 50 to connect the carrier 108 and the step structure 98 relative to one another. Such an alternative connecting structure could be provided as an alternative to the connecting structure of the fasteners 94 or in combination with the fasteners 94.

Yet further, for some aspects of the present invention, the ladder 20 could be devoid of connecting structure that extends through the ladder frame 30. For instance, if the actuator 36 is located within the path 64, the ladder 20 could be configured so that no structure connecting the actuator 36 and the step structure 98 passes through an opening in the base 50 or the ladder rails 52.

In use, the ladder 20 is configured to transport a person between the ground and the platform 26 to permit selective cab ingress and egress. When the person wants to ascend from the ground to the cab 28 (e.g., for cab ingress), the step assembly 34 is lowered to the lowermost position, if necessary. In the lowermost position, the person can readily step in an upward direction from the ground onto the step assembly 34. While supported on the step assembly 34, the person can operate the switch 110 so that the actuator 36 drives the step assembly 34 upwardly to the uppermost position. In the uppermost position, the person can step from the step assembly 34 to the platform 42. The person can then move from platform 42 to platform 26 for cab ingress.

When the person wants to descend from the cab 28 to the ground, the step assembly 34 is raised to the uppermost position, if necessary. In the uppermost position, the person can move to the platform 42 and then step downwardly onto the step assembly 34. While supported on the step assembly 34, the person can operate the switch 110 so that the actuator 36 drives the step assembly 34 downwardly to the lowermost position. In the lowermost position, the person can step downwardly from the step assembly 34 to the ground.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A powered ladder for an agricultural or industrial vehicle, wherein the ladder is operable to move a person vertically relative to the agricultural or industrial vehicle, said powered ladder comprising:
an elongated ladder frame including a pair of ladder rails that cooperatively define an upright ladder axis and a path therebetween, with the path extending along the ladder axis;
a step shiftably attached to the ladder frame and positioned at least partly within the path, with the step being shiftable along the path between upper and lower positions; and
a step drive drivingly connected relative to the step to drive the step between the upper and lower positions.

2. The powered ladder as claimed in claim 1, said step being slidably engaged with the ladder frame to slide along the ladder axis.

3. The powered ladder as claimed in claim 2, at least one of said ladder rails including a track that extends along the ladder axis; and a step assembly including the step and a connecting structure that slidably engages the track, with the connecting structure and the track cooperatively permitting sliding movement of the step along the ladder axis.

4. The powered ladder as claimed in claim 3, said track presenting a slot that extends along the ladder axis, with the connecting structure extending at least partly into the slot.

5. The powered ladder as claimed in claim 4, said connecting structure including a roller bearing that engages the slot and rotates as the step slides along the ladder axis.

6. The powered ladder as claimed in claim 4, said step drive being mounted exteriorly of the path, said connecting structure extending through the slot to drivingly interconnect the step and the step drive.

7. The powered ladder as claimed in claim 3, said step assembly including another step positioned below and fixed to the first-mentioned step, said another step being spaced below the ladder frame in the lower position.

8. The powered ladder as claimed in claim 2, said step being elongated to present opposite step ends, with each step end slidably engaged with a corresponding one of the ladder rails to slide along the ladder axis.

9. The powered ladder as claimed in claim 8, said ladder rails each including a track that extends along the ladder axis, and further comprising a step assembly including the step and a connecting structure that slidably engages the tracks, with the connecting structure and the tracks cooperatively permitting sliding movement of the step along the ladder axis.

10. The powered ladder as claimed in claim 9, said tracks each presenting a slot that extends along the ladder axis, with the connecting structure extending at least partly into the slots.

11. The powered ladder as claimed in claim 10, said connecting structure including roller bearings that each engage a respective slot and rotate as the step slides along the ladder axis.

12. The powered ladder as claimed in claim 10, said step drive being mounted exteriorly of the path, said connecting structure extending through the slots to drivingly interconnect the step and the step drive.

13. The powered ladder as claimed in claim 12, said step drive being mounted laterally between the ladder rails, said step assembly including a pair of arms, with each arm attached to a corresponding one of the step ends by the connecting structure, said arms being drivingly attached to the step drive so that operation of the step drive causes simultaneous sliding movement of the step ends.

14. The powered ladder as claimed in claim 9, said step assembly including another step positioned below and fixed to the first-mentioned step, said another step being spaced below the ladder frame in the lower position.

15. The powered ladder as claimed in claim 8, said ladder rails each including a pair of tracks that extend along the ladder axis; and a step assembly including the step and a connecting structure that slidably engages the tracks, with the connecting structure and the tracks cooperatively permitting sliding movement of the step along the ladder axis.

16. The powered ladder as claimed in claim 15, said tracks each presenting a slot that extends along the ladder axis, with the connecting structure extending at least partly into the slots.

17. The powered ladder as claimed in claim 16, said connecting structure including roller bearings that each engage a respective slot and rotate as the step slides along the ladder axis.

18. The powered ladder as claimed in claim 16, said step drive being mounted exteriorly of the path, said connecting structure extending through the slots to drivingly interconnect the step and the step drive.

19. The powered ladder as claimed in claim 18, said step drive being mounted laterally between the ladder rails, said step assembly including a pair of arms, with each arm attached to a corresponding one of the step ends by the connecting structure, said arms being drivingly attached to the step drive so that operation of the step drive causes simultaneous sliding movement of the step ends.

20. The powered ladder as claimed in claim 8, said step drive being mounted laterally between the ladder rails, said step assembly including a pair of arms, with each arm attached relative to a corresponding one of the step ends, said arms being drivingly attached to the step drive so that operation of the step drive causes simultaneous sliding movement of the step ends.
